(19) United States
(12) Patent Application Publication
(10) Pub. No.: US 2011/0029741 A1
(43) Pub. Date: Feb. 3, 2011

(54) DATA MANAGEMENT METHOD AND MEMORY DEIVCE

(75) Inventor: Wu-Chi Kuo, Kaohsiung (TW)

Correspondence Address: Wang Law Firm, Inc., 4989 Peachtree Parkway,, Suite 200, Norcross, GA, 30092, US

(73) Assignee: SILICON MOTION, INC., Jhubei (TW)

(21) Appl. No.: 12/702,944

(22) Filed: Feb. 9, 2010

(30) Foreign Application Priority Data
Jul. 30, 2009 (TW) 98125646

(51) Int. Cl. G06F 12/00; G06F 13/00

(52) U.S. Cl. 711/154; 710/52; 711/E12.001

(57) ABSTRACT

The invention provides a data management method for a memory device. In one embodiment, the memory device comprises a plurality of memories for data storage. First, write data and a write logical address is received from a host. The write logical address is then converted to a write physical address. A target memory corresponding to the write physical address is then determined. Whether the target memory is in a busy state is then checked. When the target memory is in the busy state, the write data is written to a buffer area of a substitute memory of the target memory.

### CROSS REFERENCE TO RELATED APPLICATIONS

This Application claims priority of Taiwan Patent Application No. 98125646, filed on Jul. 30, 2009, the entirety of which is incorporated by reference herein.

### BACKGROUND OF THE INVENTION

1. Field of the Invention

The invention relates to memories, and more particularly to nonvolatile memories.

2. Description of the Related Art

Memories are divided into volatile memories and nonvolatile memories.

Nonvolatile memories can keep data stored therein when power supplied to the nonvolatile memories is turned off. A memory is often installed in a memory device which stores data for a host. In one embodiment, a memory device comprises a controller and at least one memory. The memory of the memory device is for data storage, and the controller of the memory device accesses data stored in the memory according to instructions sent from a host.

When the host wants to write data to the memory device, the controller writes the data to the memory of the memory device according to a write command and a write address sent from the host. When the host sends a write command to the memory device, if the memory is not busy processing previous data written to the memory, the controller usually can complete writing operations requested by the write command to write data to the memory in a predetermined period. When the host sends a write command to the memory device, if the memory is busy processing pervious data written to the memory, the controller can not directly perform writing operations requested by the write command. Processing of the write command therefore has to wait for a delay period until the memory completes processing of the previous data. After the processing of previous data is completed, the controller can then direct the memory to perform writing operations requested by the write command. The delay period therefore negatively impacts the performance of the memory device.

Referring to FIG. 1, a flowchart of a conventional method 100 for writing data to a memory device is shown. First, a controller of the memory device receives write data and a write logical address from a host (step 102). The controller then determines a write physical address corresponding to the write physical address and a target flash memory corresponding to the write physical address (step 104). Before the write data is written to the write physical address of the target flash memory, the controller has to check whether the target flash memory is in a busy state (step 106). For example, a logical address accessed by the host corresponds to a mother memory block and a child memory block of a flash memory, wherein the child memory block stores data of updated pages of the mother memory block. When the child memory block has been filled with data of the update pages, the controller cannot write data of new update pages of the mother memory block to the child memory block. The controller therefore must combine original data stored in the mother memory block with the update data stored in the child memory block to obtain an integrated memory block. The controller therefore must expand time in processing the combination of the original data and the update data and is therefore in a busy state.

When the target flash memory is in the busy state (step 106), the controller has to wait for a predetermined period (step 108). After the predetermined period has passed, the controller determines whether the target flash memory is in the busy state again (step 106). If the target flash memory is still in the busy state, the controller still has to wait for the predetermined period (step 108). If the target flash memory is not in the busy state, the controller writes the write data to the target flash memory according to the write physical address (step 110). After the write data is written to the target flash memory, if the host sends new write data and a new write logical address to the memory device (step 110), the controller receives the new write data and the new write logical address from the host (step 102) and continues to write the new write data to a target flash memory according to the method 100.

When a target flash memory is in a busy state (step 106), the controller cannot direct the target flash memory to write data, causing a delay to the processing of the write command and negatively impacting system performance. If the delay occurs with a high frequency, the performance of the memory device is degraded. Thus, a data management method is required to shorten the delay and improve the performance of the memory device.

### BRIEF SUMMARY OF THE INVENTION

The invention provides a data management method for a memory device. In one embodiment, the memory device comprises a plurality of memories for data storage. First, write data and a write logical address is received from a host. The write logical address is then converted to a write physical address. A target memory corresponding to the write physical address is then determined. Whether the target memory is in a busy state is then checked. When the target memory is in the busy state, the write data is written to a buffer area of a substitute memory of the target memory.

The invention also provides a memory device. In one embodiment, the memory device comprises a plurality of memories and a controller. The plurality of memories is for data storage. The controller receives write data and a write logical address from a host, converts the write logical address to a write physical address, determines a target memory corresponding to the write physical address, checks whether the target memory is in a busy state, and writes the write data to a buffer area of a substitute memory of the target memory when the target memory is in the busy state.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of a conventional method for writing data to a memory device;

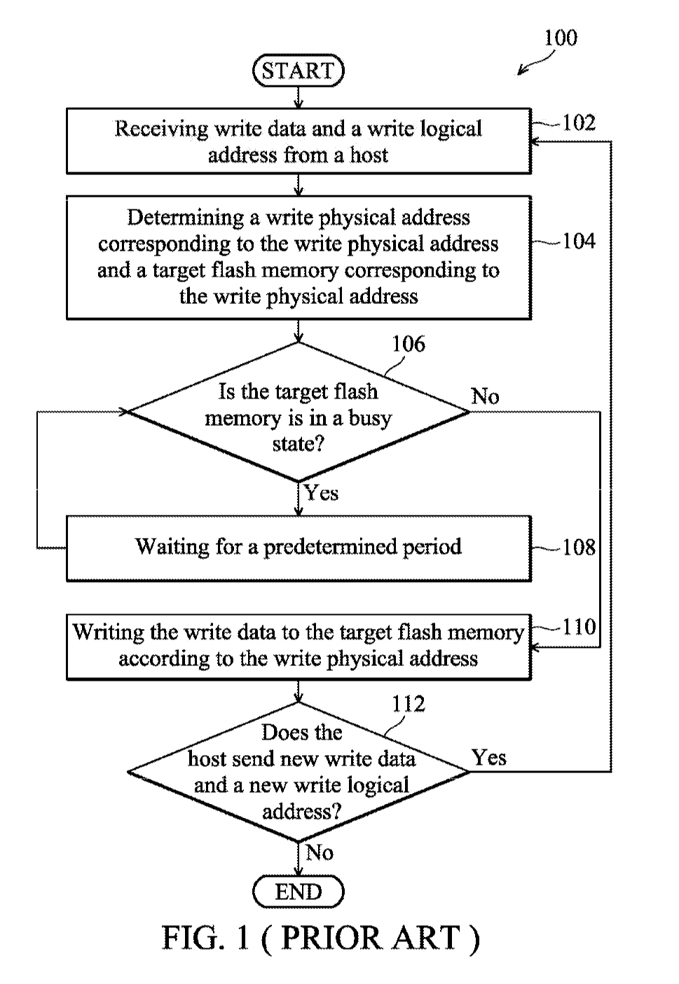

FIG. 2 is a block diagram of a data storage system according to the invention;

FIG. 3 is a flowchart of a method for writing data to a memory device according to the invention;

FIG. 4 is a schematic diagram of an embodiment of a buffer data table according to the invention; and

FIG. 5 is a flowchart of a method for writing data stored in a buffer area to a target memory according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

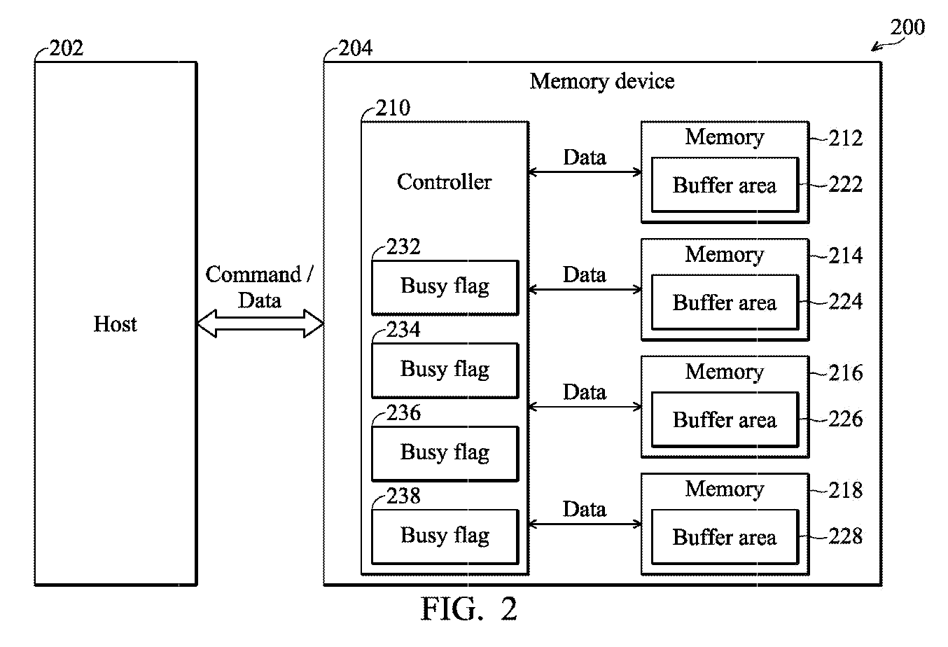

Referring to FIG. 2, a block diagram of a data storage system 200 according to the invention is shown. The data storage system 200 comprises a host 202 and a memory device 204. The memory device 204 stores data for the host 202. In one embodiment, the memory device 204 comprises a controller 210 and a plurality of memories 212, 214, 216, and 218. When the host 202 sends data access commands to the memory device 204, the controller 210 accesses data stored in the memories 212, 214, 216, and 218 according to data access commands. For example, when the host 202 sends a write command to the memory device 204, the controller 210 writes data to the memories 212, 214, 216, and 218 according to the write command. When the host 202 sends a read command to the memory device 204, the controller 210 reads data from the memories 212, 214, 216, and 218 according to the read command.

The controller 210 comprises a plurality of busy flags 232, 234, 236, and 238. The busy flags 232, 234, 236, and 238 respectively indicate whether the memories 212, 214, 216, and 218 are in a busy state. The memories 212, 214, 216, and 218 respectively have buffer areas 222, 224, 226, and 228. The buffer areas 222, 224, 226, and 228 comprise at least one memory block for data storage. In addition, each of the memories 212, 214, 216, and 218 is a substitute memory of another memory. In one embodiment, the memory 212 is a substitute memory of the memory 214, the memory 214 is a substitute memory of the memory 216, the memory 216 is a substitute memory of the memory 218, and the memory 218 is a substitute memory of the memory 212. Before the controller 210 writes data to a target memory, the controller 210 determines whether the target memory is in a busy state. When the target memory is in a busy state, the controller 210 writes the data to a buffer area of a buffer area of a substitute memory of the target memory. Thus, the controller does not need to spend time in waiting for the target memory as the conventional method 100, and a delay period is therefore shortened to improve system performance of the memory device 204. When the target memory subsequently departs from the busy state, the controller 210 can then read the data from the buffer area of the substitute memory, and then writes the data to the target memory, thus completing write operations requested by a write command.

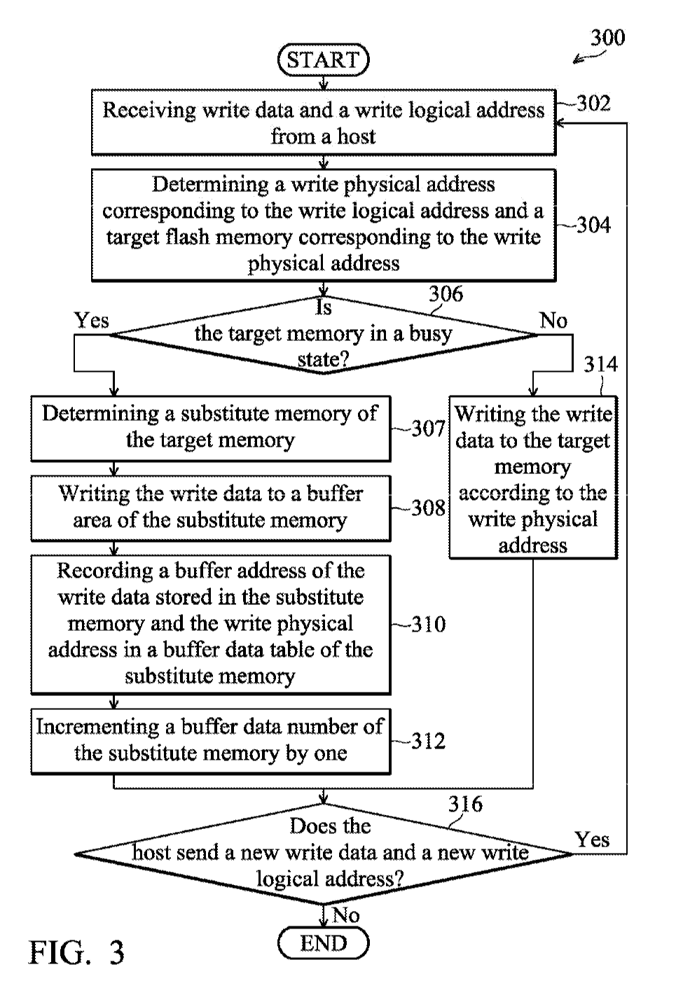

Referring to FIG. 3, a flowchart of a method 300 for writing data to the memory device 204 according to the invention is shown. First, the controller 210 receives write data and a write logical address from the host 202 (step 302). The controller 210 then determines a write physical address corresponding to the write logical address and a target memory corresponding to the write physical address (step 304). The controller 210 then checks whether the target memory is in a busy state (step 306). In one embodiment, the controller 210 checks a busy flag corresponding to the target memory to determine whether the target memory is in the busy state. When the target memory is not in the busy state (step 306), the controller 210 directly writes the write data to the target memory according to the write physical address (step 314). Otherwise, when the target memory is not in the busy state (step 306), the controller 210 cannot directly write the write data to the target memory according to the write physical address. To shorten the time period spent in waiting for the target memory, the controller 210 determines a substitute memory of the target memory (step 307), and then writes the write data to a buffer area of the substitute memory (step 308).

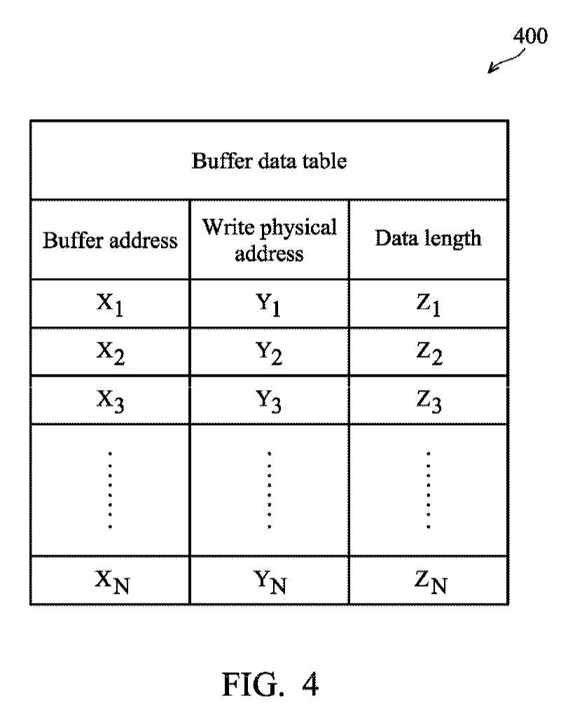

The write data has been temporarily stored in the buffer area of the substitute memory. The controller 210 therefore requires information about the address according to which the write data is stored in the buffer area for subsequent retrieving of the write data from the buffer area. The controller 210 therefore records a buffer address of the write data stored in the substitute memory in a buffer data table of the substitute memory (step 310). In addition, the controller 210 also records the write physical address corresponding to the write data in the buffer data table of the substitute memory (step 310). Thus, the buffer data table stores information about all buffered data stored in the buffer area of the substitute memory. In one embodiment, each of the memories 212, 214, 216, and 218 has a corresponding buffer data table stored in the controller 210. Referring to FIG. 4, a schematic diagram of an embodiment of a buffer data table 400 according to the invention is shown. The buffer data table stores N information records of buffered data, and the information records comprises buffered addresses of the buffered data, write physical addresses, and data length of the buffered data. The controller 210 then increments a buffer data number of the substitute memory by one (step 312), wherein the buffer data number indicates a total number of buffered data pieces stored in the buffer area of the substitute memory. In one embodiment, each of the memories 212, 214, 216, and 218 has a corresponding buffer data number stored in the controller 210. Finally, if the host 202 sends new write data and a new write logical address to the memory device 204 (step 316), the controller 210 continues to receive the new write data and the new write logical address from the host (step 302), and processes the new write data according to the method 300.

For example, assume that the host 202 wants to write new write data to the memory 216, and the memory 216 is currently in a busy state and cannot receive the new write data. Because the memory 214 is a substitute memory of the memory 216, the controller 210 therefore writes the new write data to the buffer area 224 of the memory 214. The controller 210 then records information about the new write data in a buffer data table corresponding to the memory 215, and increments a buffer data number corresponding to the memory 214 by one. The controller 210 can then receive subsequent write data from the host 202 and process the subsequent write data. Because the controller 210 does not need to wait until the memory 216 moves off the busy state and can immediately process subsequent write data, a delay time period is therefore shortened, and performance of the memory device 200 is improved.

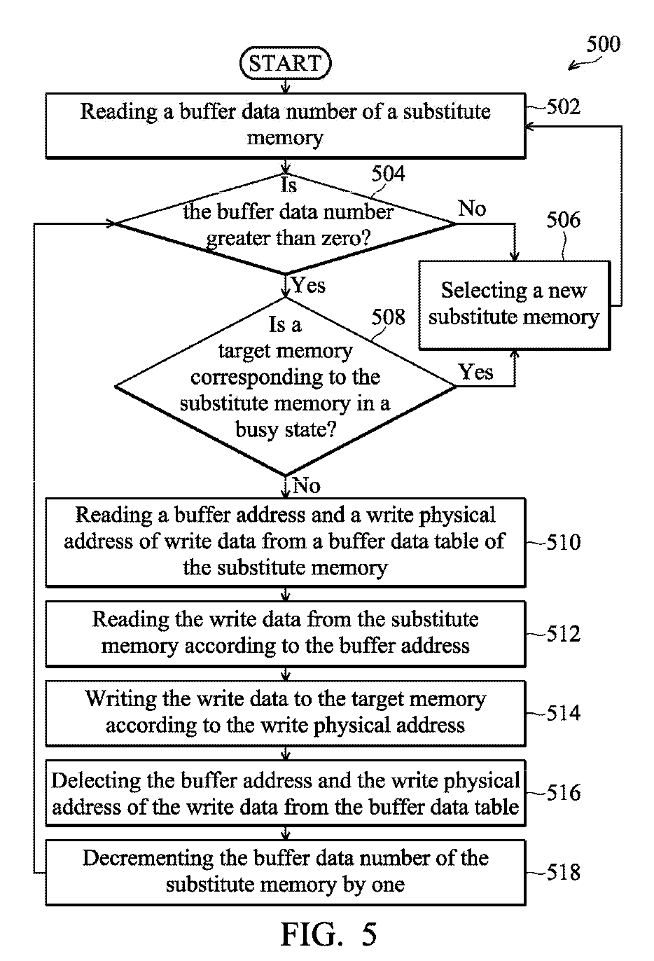

After the target memory moves off the busy state, the controller 210 must retrieve the write data from the buffer area of the substitute memory, and then writes the write data to the target memory to complete write operations requested by a write command. Referring to FIG. 5, a flowchart of a method 500 for writing data stored in a buffer area to a target memory according to the invention is shown. First, the controller 210 reads a buffer data number of a substitute memory (step 502). When the buffer data number is equal to zero, the substitute memory stores no write data, and the controller 210 selects a new substitute memory from the memories 212, 214, 216, and 218 (step 506) and determines whether the buffer data number of the new substitute memory is greater than zero. When the buffer data number is greater than zero (step 504), the substitute memory stores write data, and the controller 210 then checks whether a target memory corresponding to the substitute memory is in a busy state (step 508). When the target memory is in the busy state, the controller 210 cannot write data to the target memory, and the controller 210 selects a new substitute memory from the memories 212, 214, 216, and 218 (step 506). When the target memory is not in the busy state (step 508), the controller 210 can retrieve write data from the substitute memory and write the write data to the target memory.

First, the controller 210 reads a buffer address and a write physical address of the write data from a buffer data table of the substitute memory (step 510). The controller 210 then directs the substitute memory to read the write data from the buffer area of the substitute memory according to the buffer address (step 512). After the controller 210 receives the write data from the substitute memory, the controller 210 directs the target memory to write the write data to the target memory according to the write physical address (step 514). The write data stored in the buffer area of the substitute memory is therefore useless, and the controller 210 then directs the substitute memory to erase the write data from the buffer area of the substitute memory. The information stored in the buffer data table corresponding to the substitute memory is also useless, and the controller 210 deletes the buffer address and the write physical address of the write data from the buffer data table corresponding to the substitute memory (step 516). Finally, the controller 210 decrements the buffer data number of the substitute memory by one (step 518).

For example, assume that the controller 210 finds that a buffer data number of the substitute memory 214 is greater than zero. The controller 210 therefore determines a target memory 216 corresponding to the substitute memory 214, and checks whether the target memory 216 is in a busy state. If the target memory 216 is not in the busy state, the controller 216 retrieves write data from the buffer area of the substitute memory 214, and writes the write data to the target memory 216. Thus, when the target memory moves off a busy state, the controller 210 can write the write data back to the target memory according to the method 500 to complete write operations requested by the host 202.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data management method for a memory device, wherein the memory device comprises a plurality of memories for data storage, the method comprising:
receiving write data and a write logical address from a host;
converting the write logical address to a write physical address;
determining a target memory corresponding to the write physical address;
checking whether the target memory is in a busy state; and
when the target memory is in the busy state, writing the write data to a buffer area of a substitute memory of the target memory.

2. The data management method as claimed in claim 1, wherein the data management method further comprises:
when the target memory is not in the busy state, writing the write data to the target memory according to the write physical address.

3. The data management method as claimed in claim 1, wherein the memories respectively have corresponding busy flags in a controller, and checking whether the target memory is in the busy state comprises checking the busy flag corresponding to the target memory to determine whether the target memory is in the busy state.

4. The data management method as claimed in claim 1, wherein after the write data is written to the buffer area of the substitute memory, the data management method further comprises:
recording a buffer address of the write data stored in the buffer area and the write physical address in a buffer data table of the substitute memory; and
incrementing a buffer data number of the substitute memory by one.

5. The data management method as claimed in claim 4, wherein after the write data is written to the buffer area of the substitute memory, the data management method further comprises recording a data length of the write data in the buffer data table.

6. The data management method as claimed in claim 4, wherein the data management method further comprises:
checking whether the target memory is in the busy state;
when the target memory is not in the busy state, reading the buffer address and the write physical address from the buffer data table of the substitute memory;
reading the write data from the buffer area of the substitute memory according to the buffer address; and
writing the write data to the target memory according to the write physical address.

7. The data management method as claimed in claim 6, wherein the data management method further comprises:
after the write data is written to the target memory, deleting the write data from the buffer area of the substitute memory;
deleting the buffer address of the write data and the write physical address from the buffer data table of the substitute memory; and
decrementing the buffer data number of the substitute memory by one.

8. The data management method as claimed in claim 4, wherein the data management method further comprises:
determining whether the buffer data number of the substitute memory is equal to zero;
checking whether the target memory is in the busy state;
when the target memory is not in the busy state and the buffer data number of the substitute memory is not equal to zero, reading the buffer address and the write physical address from the buffer data table of the substitute memory;
reading the write data from the buffer area of the substitute memory according to the buffer address; and
writing the write data to the target memory according to the write physical address.

9. The data management method as claimed in claim 1, wherein each of the memories serves as a substitute memory of another one of the memories.

10. The data management method as claimed in claim 1, wherein the memories are nonvolatile memories.

11. A memory device, comprising:
a plurality of memories, for data storage; and
a controller, receiving write data and a write logical address from a host, converting the write logical address to a write physical address, determining a target memory corresponding to the write physical address, checking whether the target memory is in a busy state, and writing the write data to a buffer area of a substitute memory of the target memory when the target memory is in the busy state.

12. The memory device as claimed in claim 11, wherein when the target memory is not in the busy state, the controller writes the write data to the target memory according to the write physical address.

13. The memory device as claimed in claim 11, wherein the memories respectively have corresponding busy flags in a controller, and the controller checks the busy flag corresponding to the target memory to determine whether the target memory is in the busy state.

14. The memory device as claimed in claim 11, wherein after the write data is written to the buffer area of the substitute memory, the controller records a buffer address of the write data stored in the buffer area and the write physical address in a buffer data table of the substitute memory, and increments a buffer data number of the substitute memory by one.

15. The memory device as claimed in claim 14, wherein after the write data is written to the buffer area of the substitute memory, the controller further records a data length of the write data in the buffer data table.

16. The memory device as claimed in claim 14, wherein the controller further checks whether the target memory is in the busy state, and when the target memory is not in the busy state, the controller reads the buffer address and the write physical address from the buffer data table of the substitute memory, reads the write data from the buffer area of the substitute memory according to the buffer address, and writes the write data to the target memory according to the write physical address.

17. The memory device as claimed in claim 16, wherein after the write data is written to the target memory, the controller deletes the write data from the buffer area of the substitute memory, deletes the buffer address of the write data and the write physical address from the buffer data table of the substitute memory, and decrements the buffer data number of the substitute memory by one.

18. The memory device as claimed in claim 14, wherein the controller determines whether the buffer data number of the substitute memory is equal to zero, checks whether the target memory is in the busy state, and when the target memory is not in the busy state and the buffer data number of the substitute memory is not equal to zero, the controller reads the buffer address and the write physical address from the buffer data table of the substitute memory, reads the write data from the buffer area of the substitute memory according to the buffer address, and writes the write data to the target memory according to the write physical address.

19. The memory device as claimed in claim 11, wherein each of the memories serves as a substitute memory of another one of the memories.

20. The memory device as claimed in claim 11, wherein, the memories are nonvolatile memories.
